(19) United States
(12) Patent Application Publication
(10) Pub. No.: US 2010/0194297 A1
(43) Pub. Date: Aug. 5, 2010

(54) Light string device

(76) Inventor: Chen-Sheng Yang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,797

(22) Filed: Feb. 5, 2009

(51) Int. Cl. F21S 4/00; H05B 37/02

(52) U.S. Cl. 315/185 S; 315/294

(57) ABSTRACT

The present invention discloses a light string device to solve the problem of a limited LED quantity in the conventional technology. The light string device of the present invention comprises a plug containing a full-wave voltage-doubling circuit. The full-wave voltage-doubling circuit converts an AC power into a high-voltage signal powering the light string, whereby the present invention can increase the quantity or brightness of LEDs in the light string without replacing the power supply or increasing the cost.

### BACKGROUND OF THE INVENTION

1. Field of the Invention

The present invention relates to a decorative light string device, particularly to a decorative light string device formed of LEDs.

2. Description of the Related Art

Light strings are usually used in shops, festivals, wedding ceremonies, concerts, etc. In traditional light strings, common colored light bulbs are externally attached to the cables. With the advance of science and technology, LEDs (Light Emitting Diode) replace the power-consuming light bulbs. Currently, the light string available in the market is usually formed of a plurality of LEDs.

The color and the light efficiency of LED correlate with the material and fabrication process thereof. There have been red, green, blue and white LEDs available in the market. The working voltage of LED is only 1.5-3 volts. Therefore, LED is a power-efficient device. LED can actively emit light having a considerable brightness. Further, the brightness of LED can be regulated via adjusting the voltage or current thereof. Furthermore, LED features impact resistance, vibration resistance and a long service life.

Refer to FIG. 1. The conventional light string device 10 has a plug 12 containing a power converter 14. The plug 12 is connected to a plurality of LEDs 16. The power source 18, the power converter 14 and the LEDs 16 form a loop. However, the quantity and brightness of the LEDs 16 is limited by the voltage of the power source 18.

Therefore, the present invention proposes a voltage-boost light string device to solve the abovementioned problem.

### SUMMARY OF THE INVENTION

The primary objective of the present invention is to provide a light string device having a full-wave voltage-doubling circuit in the plug thereof, wherein the full-wave voltage-doubling circuit can provide a DC (Direct Current) voltage doubling the peak voltage of the supplied AC (Alternating Current) power, whereby the quantity or brightness of LEDs can be increased without replacing the power supply or increasing the cost.

The light string device disclosed by the present invention comprises a plug and at least one light string connected to the plug. The plug comprises a casing, a full-wave voltage-doubling circuit, and a set of electric-conduction plug blades connected with the full-wave voltage-doubling circuit and a power supply. The power supply provides an AC power for the plug blades, and the plug blades transmit the AC power to the full-wave voltage-doubling circuit. The full-wave voltage-doubling circuit converts the AC power into a high-voltage signal and outputs the high-voltage signal to the light string. The LEDs of the light string is thus powered to emit light.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing the circuit of a conventional light string device;

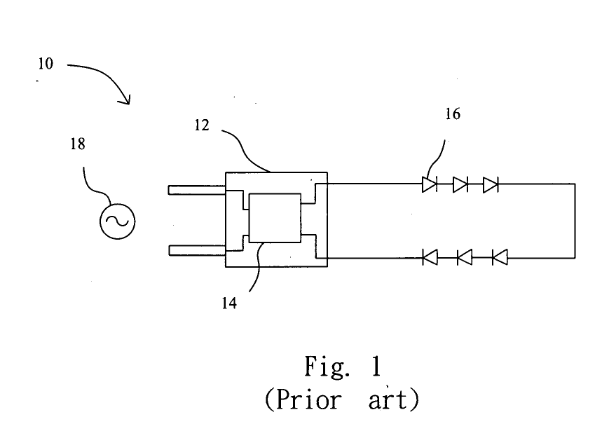

FIG. 2 is a diagram schematically showing the circuit of a light string device according to one embodiment of the present invention; and

FIG. 3 is a perspective view of a light string device according to one embodiment of the present invention.

### DETAILED DESCRIPTION OF THE INVENTION

The present invention proposes a light string device, wherein the quantity of LEDs of a light string is increased without consuming too much electric power. Below, the technical contents of the present invention are described in detail with the embodiments and the drawings.

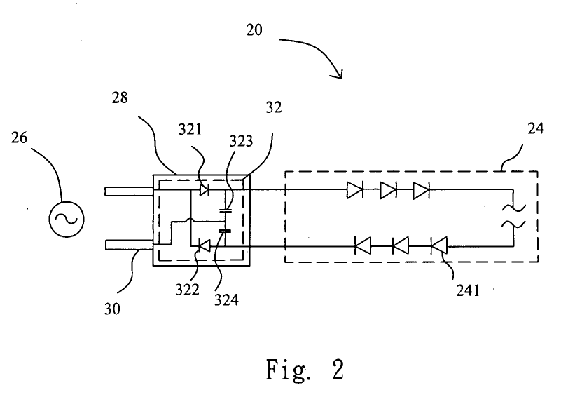

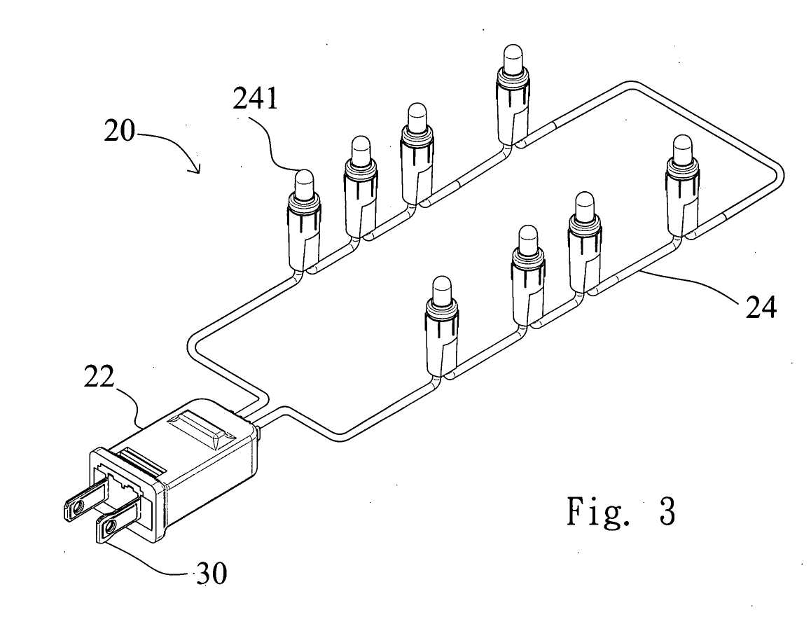

Refer to FIG. 2 and FIG. 3 for an embodiment of the present invention. In the embodiment of the present invention, the light string device 20 comprises a plug 22 and at least one light string 24 connected to the plug 22. The plug 22 can be electrically connected with a power supply 26. The plug 22 includes a plastic casing 28, a set of electric-conduction plug blades 30, and a full-wave voltage-doubling circuit 32 connected to the plug blades 30. The light string 24 is formed of a plurality of cascaded LEDs 241 and connected with the full-wave voltage-doubling circuit 32. The plug blades 30 receive an AC power from the power supply 26 and transfer the AC power to the full-wave voltage-doubling circuit 32. The full-wave voltage-doubling circuit 32 converts the AC power into a high-voltage signal and outputs the high-voltage signal to the light string 24 to drive the LEDs 241 to emit light.

As shown in FIG. 2, the full-wave voltage-doubling circuit 32 includes two rectifier diodes 321 and 322 and two capacitors 323 and 324 coupled to the rectifier diodes 321 and 322. The two rectifier diodes 321 and 322 receive the AC power provided by the power supply 26 via the plug blades 30 and process the AC power into two directions of current signals to respectively charge the two capacitors 323 and 324. Then the two capacitors 323 and 324 release high-voltage signals having a voltage doubling the peak voltage of the AC power, and the high-voltage signals are stable DC voltage signals. In the present invention, the full-wave voltage-doubling circuit 32 inside the plug 22 provides high-voltage signals for the light string 24. With the power of the power supply remaining unchanged, the present invention can thus increase the quantity of the LEDs 241 or enhance the brightness of the LEDs 241 of the light string 24 having the original quantity.

In the present invention, when the plug blades 30 of the plug 22 of the light string device 20 are inserted into the power supply 26, the power supply 26 provides an AC power for the full-wave voltage-doubling circuit 32 via the plug blades 30; the full-wave voltage-doubling circuit 32 converts the AC power into a high-voltage signal and outputs the high-voltage signal to the light string 24 to make the LEDs 241 emit light. Compared with the conventional technology, the light string device of the present invention may have more LEDs 241 in the light string or have higher brightness of LEDs 241 with the quantity of LEDs 241 remaining unchanged. Because of the increased quantity or enhanced brightness of LEDs, the present invention can make a space present a fresh and vivid visual effect.

The embodiments described above are to demonstrate the technical contents and characteristics of the present invention to enable the persons skilled in the art to understand, make, and use the present invention. However, it is not to limit the scope of the present invention. Any equivalent modification or variation according to the spirit of the present invention is to be also included within the scope of the present invention.

What is claimed is:

1. A light string device comprising
a plug including
a casing;
a set of electric-conduction plug blades arranged in said casing and able to connect with a power supply; and
a full-wave voltage-doubling circuit arranged inside said casing, connected with said electric-conduction plug blades, receiving an alternating-current power, converting said alternating-current power into a high-voltage signal and outputting said high-voltage signal; and
at least one light string electrically connected with said full-wave voltage-doubling circuit and receiving said high-voltage signal to emit light.

2. The light string device according to claim 1, wherein said light string includes a plurality of cascaded light-emitting diodes.

3. The light string device according to claim 1, wherein said casing is made of a plastic material.

4. The light string device according to claim 1, wherein said high-voltage signal has a voltage doubling a peak voltage of said alternating-current power.

5. The light string device according to claim 1, wherein said high-voltage signal is a stable direct-current signal.
